(19) United States
(12) Patent Application Publication
(10) Pub. No.: US 2011/0247658 A1
(43) Pub. Date: Oct. 13, 2011

(54) Apparatus and method for cleaning a camera module

(75) Inventors: Young Hoon Kwak, Gyunggi-do (KR); Young Keun Heo, Gyunggi-do (KR)

(73) Assignee: SAMSUNG ELECTRO-MECHANICS CO., LTD., Gyunggi-do (KR)

(21) Appl. No.: 12/803,906

(22) Filed: Jul. 9, 2010

(30) Foreign Application Priority Data
Apr. 8, 2010 (KR) 10-2010-0032438

(51) Int. Cl. B08B 5/04; A47L 5/00

(52) U.S. Cl. 134/21; 15/300.1

(57) ABSTRACT

Disclosed are an apparatus for cleaning a camera module, including: a housing in which a camera module, the object to be cleaned, is received, an opening/closing unit that opens/closes the housing, and an air suction unit that is connected to the housing and discharges air in the housing to the outside, and a method for cleaning the camera module. The apparatus and the method for cleaning the camera module remove the fine foreign substances of the camera in such a manner that the instantaneous velocity of air supplied to the camera module is increased by receiving the camera module, the object to be cleaned, in a negative pressure state, and breaking the negative pressure state, thereby making it possible to clean the complicated and narrow inside of the camera module, and generates vibration to the supplied air using the opening/closing unit that is rapidly and repeatedly opened/closed, thereby making it possible to more effectively remove the fine foreign substances.

### CROSS REFERENCE TO RELATED APPLICATION

This application claims the benefit of Korean Patent Application No. 10-2010-0032438, filed on Apr. 8, 2010, entitled “Apparatus and method for cleaning a camera module”, which is hereby incorporated by reference in its entirety into this application.

### BACKGROUND OF THE INVENTION

1. Technical Field

The present invention relates to an apparatus and a method for cleaning a camera module.

2. Description of the Related Art

In general, a camera module performs a cleaning process for removing fine foreign substances during an assembly process. In particular, the internal structure of a camera module is very complicated and the space between the internal and external structures is very narrow so that fine foreign substances of about 10-100 μm remain in the narrow space of structure of about 100-200 μm. Therefore, if such fine foreign substances are not removed, defects occur due to the foreign substances on a screen.

As a cleaning process for removing the fine foreign substances according to the related art, there are a compressed air injection method and a suction method. The compressed air injection method removes fine foreign substances by injecting high-pressure air to the opening onth upper surface of a camera module, the object to be cleaned, using an air nozzle, and the suction method simply sucks air through the opened gap of the camera module.

More specifically, FIG. 1 is a diagram schematically showing the use of an apparatus for cleaning a camera module according to an embodiment of the related art. As shown in FIG. 1, the apparatus for cleaning the camera module includes an air nozzle 10 and a housing 20, wherein a camera module 30, the object to be cleaned, is inserted into the housing 20.

High-pressure air is then injected through the air nozzle 10, such that the fine foreign substances of the camera module 30 are removed. The air nozzle injection method is performed as described above, such that the fine foreign substances on the external surface of the camera module 30 that is positioned on the upper portion of the housing 20 can be easily removed. However, a problem occurs in that the fine foreign substances positioned inside the camera module having a complicated structure are not removed and the removal efficiency of the fine foreign substances is very low in respect to the entire amount of air injected from the air nozzle.

FIG. 2 is a diagram schematically showing the use of an apparatus for cleaning a camera module according to another embodiment of the related art. As shown in FIG. 2, the apparatus for cleaning the camera module includes a housing 20 and an air suction unit 40, wherein a camera module 30, the object to be cleaned, is inserted into the housing 20. Air flows in such a manner that the air inside the housing is sucked out by the air suction unit 40 positioned at the lower portion of the housing, such that the fine foreign substances of the camera module 30 are removed. As a specific experimental example, when the air is sucked out at a pressure of −0.5×10⁵ pa by the air suction unit, the pressure at the lower portion of the camera module is about −0.4×10⁵ pa while the average speed of air in the camera module is 13.7 m/s.

However, the average speed of air at steady condition in the camera module of 13.7 m/s is a relatively low velocity considering that the instantaneous maximum average speed in the camera module is 38 m/s or 45.2 m/s when using the apparatus for cleaning the camera module according to the present invention to be described later.

As described above, the simple suction method according to the related art can efficiently introduce air into the inside of the camera module as compared to the air nozzle injection method. However, the suction method cannot efficiently remove the fine foreign substances inside the camera module due to a small amount of physical impact for removing the fine foreign substances.

Therefore, the apparatus for cleaning the camera module according to the air nozzle injection method or the suction method that is the related art cannot efficiently remove the fine foreign substances positioned between narrow structures in the camera module.

### SUMMARY OF THE INVENTION

The present invention has been made in an effort to provide an apparatus for cleaning a camera module that can clean a complicated and narrow inside of a camera module by removing fine foreign substances in the camera module in such a manner that the instantaneous velocity of air to be supplied to the camera module is increased by receiving the camera module, the object to be cleaned, in a negative pressure state and breaking the negative pressure state, and a method for cleaning the camera module.

Another object of the present invention is to provide an apparatus for cleaning a camera module that can effectively remove fine foreign substances by supplying air to the camera module by receiving the camera module in a negative pressure state and breaking the negative pressure state, simultaneously with generating vibration to the induced air using an opening/closing unit that rapidly and repeatedly opens/closes the upper portion of a housing, and a method for cleaning the camera module.

Another object of the present invention is to provide an apparatus for cleaning a camera module that can more effectively remove fine foreign substances by receiving the camera module in a negative pressure state and breaking the negative pressure state, simultaneously with generating vibration to the pressurized air using an opening/closing unit that is rapidly and repeatedly opened/closed, and a method for cleaning the camera module.

An apparatus for cleaning a camera module according to a first embodiment of the present invention includes: a housing in which a camera module, the object to be cleaned, is received; an opening/closing unit that opens/closes the housing; and an air suction unit that is connected to the housing and discharges air in the housing to the outside.

The opening/closing unit may be configured to include an opening/closing jig or a solenoid valve that repeatedly opens/closes the housing.

Further, the opening/closing unit may include a sealing member that is positioned on a contact portion connected to the housing, wherein the sealing member may be configured to include a pad made of silicon or rubber.

Further, the air suction unit may include a suction jig that is connected to the housing; and an air suction pump that discharges air in the housing to the outside.

The suction jig may include the sealing member that is positioned on the contact portion connected to the housing and is configured to include the pad made of silicon or rubber.

An apparatus for cleaning a camera module according to a second embodiment of the present invention includes: a housing in which a camera module, the object to be cleaned, is received; an air injection and sealing unit that seals the housing and includes a compressed air injection apparatus that selectively injects compressed air to the camera module in the housing; and an air suction unit that is connected to the housing and discharges air in the housing to the outside.

Further, the air injection and sealing member has an air path therein in order to transfer high-pressure air from the compressed air injection apparatus to the housing, wherein a diffuser having a diameter increased toward the housing is formed on an end of the air path.

The air injection and sealing unit may further include an opening/closing unit that opens/closes the air path, wherein the opening/closing unit may be configured to include a solenoid valve.

Further, the air suction unit may include a suction jig that is connected to the housing and an air suction pump, wherein the suction jig may further include a sealing unit that is positioned on a contact portion coupled to the housing. The sealing unit may be configured to include a pad made of silicon or rubber.

A method for cleaning a camera module according to the present invention includes: receiving a camera module, the object to be cleaned, in a housing; sealing the housing an opening/closing unit; discharging air in the housing to the outside using an air suction unit; and repeatedly opening/closing the housing the opening/closing unit so that air is introduced into the inside of the housing.

The method for cleaning the camera module may further include: injecting compressed air when the housing is opened so that air is introduced into the upper portion of the housing.

The opening/closing unit may be configured to include a solenoid valve and the air supplied to the inside of the housing may be vibrated by the repetitive opening/closing of the solenoid valve.

In addition, the possible vibration frequency range of the air generated by the solenoid valve is 1 to 200 Hz.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a diagram schematically showing the use of an apparatus for cleaning a camera module according to an embodiment of the related art;

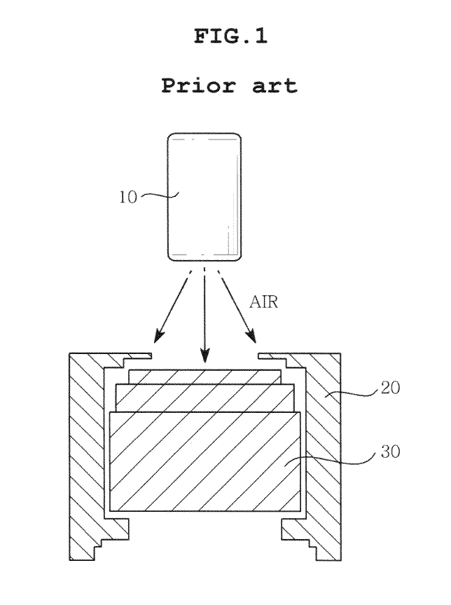

FIG. 2 is a diagram schematically showing the use of an apparatus for cleaning a camera module according to another embodiment of the related art;

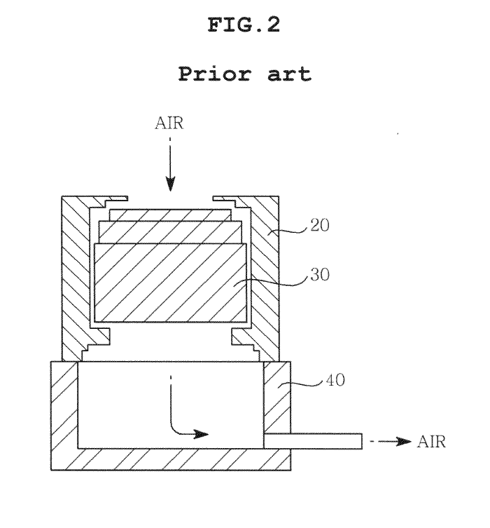

FIG. 3 is a schematic configuration diagram showing an apparatus for cleaning a camera module according to a first embodiment of the present invention;

FIG. 4 is a diagram schematically showing the use of the apparatus for cleaning the camera module of FIG. 3;

FIG. 5 is a schematic configuration diagram showing an apparatus for cleaning a camera module according to a second embodiment of the present invention;

FIG. 6 is a diagram schematically showing the use of the apparatus for cleaning the camera module of FIG. 5;

FIG. 7 is a diagram schematically showing the velocity distribution in a camera module over time in the apparatus for cleaning the camera module according to the first embodiment of the present invention;

FIG. 8 is a diagram schematically showing the velocity distribution in a camera module over time in the apparatus for cleaning the camera module according to the first embodiment of the present invention;

FIG. 9 is a diagram schematically showing a velocity distribution in a camera module over time in the apparatus for cleaning the camera module according to the first embodiment of the present invention;

FIG. 10 is a graph schematically showing a velocity change in a camera module over time in the apparatus for cleaning the camera module according to the first embodiment of the present invention; and

FIG. 11 is a graph schematically showing a velocity change in a camera module over time in the apparatus for cleaning the camera module according to the second embodiment of the present invention.

### DESCRIPTION OF THE PREFERRED EMBODIMENTS

The features and advantages of the present invention will be more obvious from the following description with reference to the accompanying drawings.

Terms or words used in the specification and claims herein should be not construed as a general and lexical meaning and should be construed as the meaning and concept meeting the technical idea of the present invention based on a principle that the present inventors can properly define the concepts of terms in order to elucidate their own invention in the best method.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, “one surface”, “the other surface” and so on are used to distinguish one element from another element, and the elements are not defined by the above terms. In describing the present invention, a detailed description of related known functions or configurations will be omitted so as not to obscure the gist of the present invention.

Hereinafter, exemplary embodiments of the present invention will be described in detail with reference to the accompanying drawings.

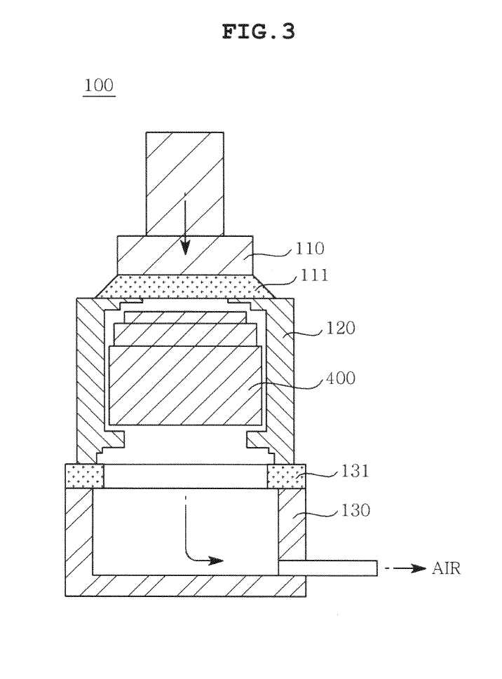

FIG. 3 is a schematic configuration diagram showing an apparatus for cleaning a camera module according to a first embodiment of the present invention. As shown in FIG. 3, the apparatus 100 for cleaning the camera module includes an opening/closing unit 110, a housing 120 and an air suction unit.

More specifically, the housing 120 receives a camera module 400 (for example, a lens barrel), the object to be cleaned, and the upper and lower portions thereof are opened and a camera module receiving unit is formed therein.

The opening/closing unit 110 opens/closes the opened upper portion of the housing 120, and is configured to include an opening/closing jig that can be repeatedly opened/closed or a solenoid valve that can be rapidly opened/closed. Further, the opening/closing unit 110 includes a sealing member 111 that more efficiently seals the opened upper portion of the housing 120.

It is preferable that the sealing member 111 is formed at the lower end of the opening/closing unit 110 in order to contact the upper portion of the housing 120 and is configured to include a pad made of silicon or rubber in order to maximally prevent the leakage of air.

The air suction unit discharges the air in the housing 120 in which the camera module 400 is received to the outside and includes a suction jig 130 and an air suction pump (not shown). The suction jig 130 includes a sealing member 131 that is connected to the lower portion of the housing 120 and is closely coupled to the housing, wherein it is preferable that the sealing member 131 is positioned on a contact portion connected to the housing and is configured to include a pad made of silicon or rubber in order to maximally prevent the leakage of the air.

In addition, it is preferable that a cleaning process using the apparatus 100 for cleaning the camera module according to the first embodiment of the present invention is formed in a cleanroom booth in order to prevent air introduced from the outside from being polluted. It is preferable that the movable fine foreign substances removed from the module are prevented from reattaching due to static electricity by installing an ionizer on the upper portion of the booth.

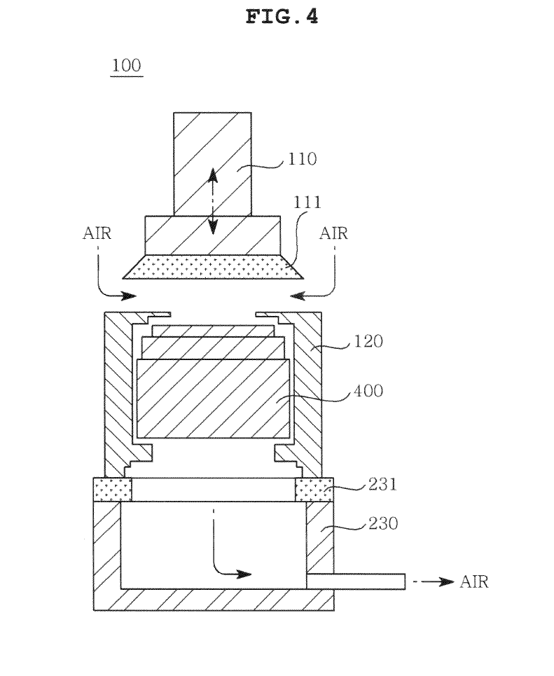

FIG. 4 is a diagram schematically showing the use of the apparatus for cleaning the camera module of FIG. 3.

As the apparatus 100 for cleaning the camera module according to the first embodiment of the present invention is formed as described above, the air in the housing is discharged to the outside by the air suction unit in a state in which the camera module 400 is received in the housing 120 and the upper portion of the housing 120 is sealed using the opening/closing unit 110, such that the internal pressure of the housing 120 is maximally lowered to remain in a negative-pressure state. The upper portion of the housing is rapidly opened/closed using the opening/closing jig or the solenoid valve, that is the opening/closing unit 110, such that the negative pressure state is broken and air is rapidly introduced into the inside of the housing simultaneously with forming vibration in the introduced air using the solenoid valve, thereby making it possible to efficiently remove the fine foreign substances in the complicated camera module.

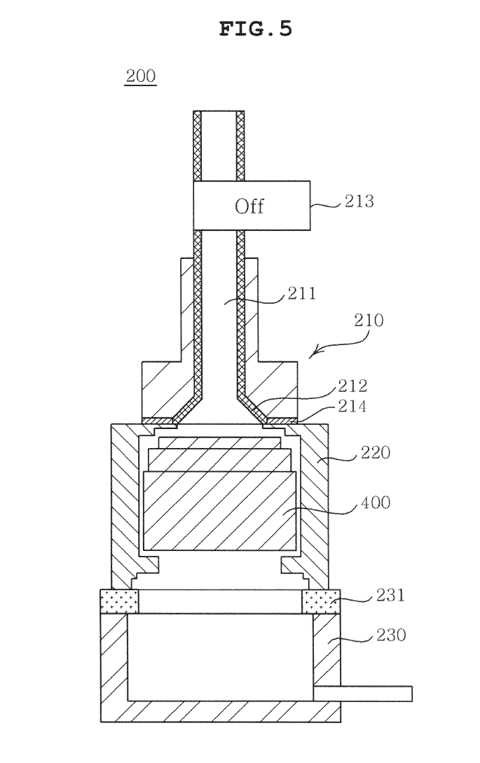

FIG. 5 is a schematic configuration diagram showing an apparatus for cleaning a camera module according to a second embodiment of the present invention. As shown in FIG. 5, the apparatus 200 for cleaning the camera module includes an air injection and sealing unit 210, a housing 220 and an air suction unit.

More specifically, the air injection and sealing unit 210 seals the opened portion of the housing 220 and includes an compressed air injection apparatus (not shown) to inject compressed air into the inside of the housing in which the camera module, the object to be cleaned, is received. It is preferable that the compressed air is implemented as positive-pressure ionized clean air.

The reason is that when the ionized clean air is used as the compressed air, it may be used without limitation anywhere cleanness of an environment needs to be managed, without performing a cleaning process in a cleaning room, different from the apparatus for cleaning the camera module according to the first embodiment of the present invention.

In addition, the air injection and sealing unit 210 has an air path 211 and a diffuser 212 formed therein and includes an opening/closing unit 213 that opens/closes the air path 212. The air path 211 transfers the high-pressure air injected from the compressed air injection apparatus to the housing, and the diffuser 212 more efficiently transfers the high-pressure air to an object to be cleaned having a relatively broader area than the air path and is formed on the end of the air path 211 having the diameter increased towards the housing. The air injection and sealing unit 210 further includes a sealing member 214 that more efficiently seals the opened upper portion of the housing 220. Further, the diffuser 212 may be selectively formed on the sealing member 214 rather than the air path 211.

In addition, it is preferable that the opening/closing unit 213 is configured to include a solenoid valve that can be rapidly and repeatedly opened/closed.

The air suction unit discharges the air in the housing 220 in which the camera module 400 is received to the outside and includes a suction jig 230 and an air suction pump (not shown). Further, the suction jig 230 includes a sealing member 231 that is connected to the lower portion of the housing 220 and is closely coupled to the housing, wherein the sealing member 231 is positioned on a contact portion connected to the housing. It is preferable that the sealing member 231 is configured to include a pad made of silicon or rubber in order to maximally prevent the leakage of air.

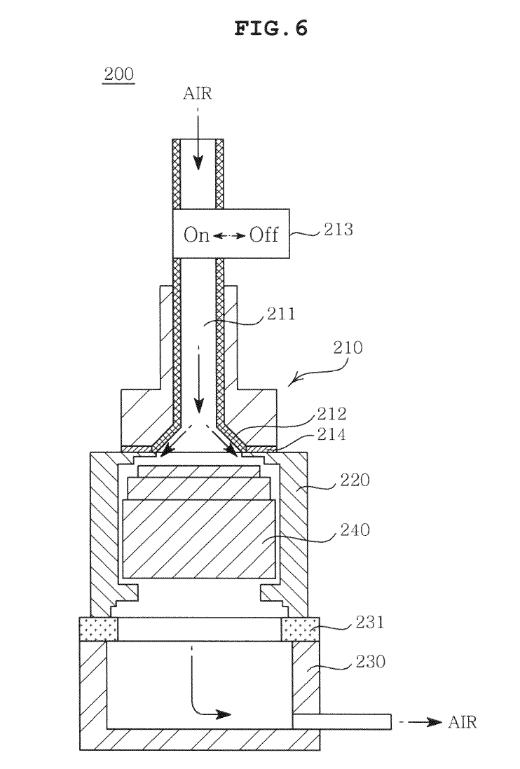

FIG. 6 is a diagram schematically showing the use of the apparatus for cleaning the camera module of FIG. 5.

As the apparatus 200 for cleaning the camera module according to the second embodiment of the present invention is formed as described above, the air in the housing 220 is discharged to the outside by the air suction unit in a state in which the camera module 400 is received in the housing 220 and the opened upper portion of the housing 220 is sealed using the air injection and sealing unit 210, such that the internal pressure of the housing 220 is maximally lowered to remain in a negative pressure state. The solenoid valve 213 that is the opening/closing unit of the air injection and sealing unit rapidly opens/closes the sealed upper portion of the housing, while injecting the compressed air into the inside of the housing by the compressed air injection apparatus, such that the injected compressed air is vibrated, thereby making it possible to more effectively remove the fine foreign substances in the complicated camera module.

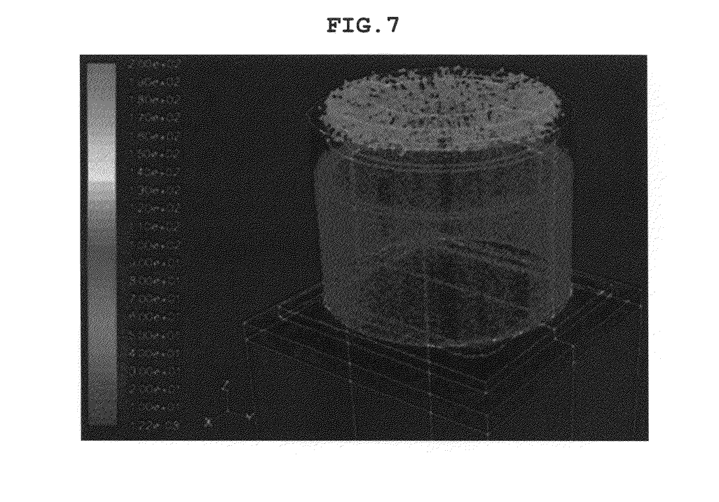

FIGS. 7 to 9 are diagrams schematically showing the velocity distribution in a camera module over time in the apparatus for cleaning the camera module according to the first embodiment of the present invention That is, FIGS. 7 to 9 shows the velocity distribution in the camera module over time when the inside of the housing remains in a negative pressure state by discharging the air in the housing in which the camera module, the object to be cleaned, is received, to the outside using the air suction unit and the air outside the housing is introduced into the inside of the housing by opening the housing the opening/closing unit.

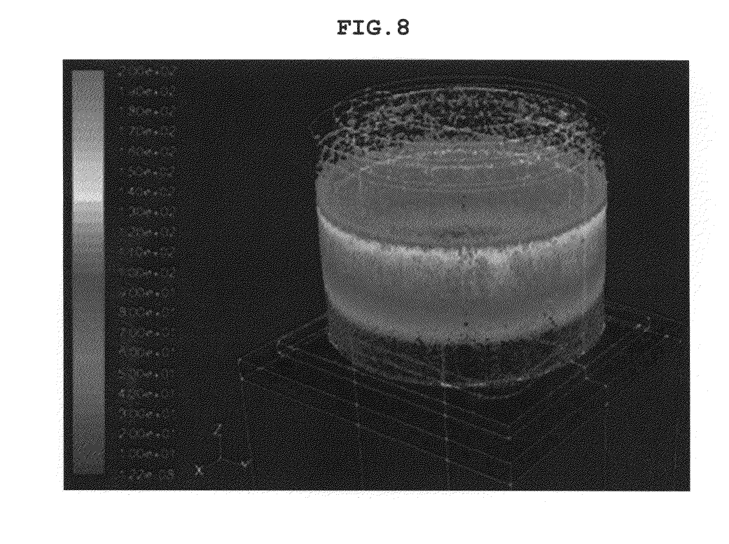

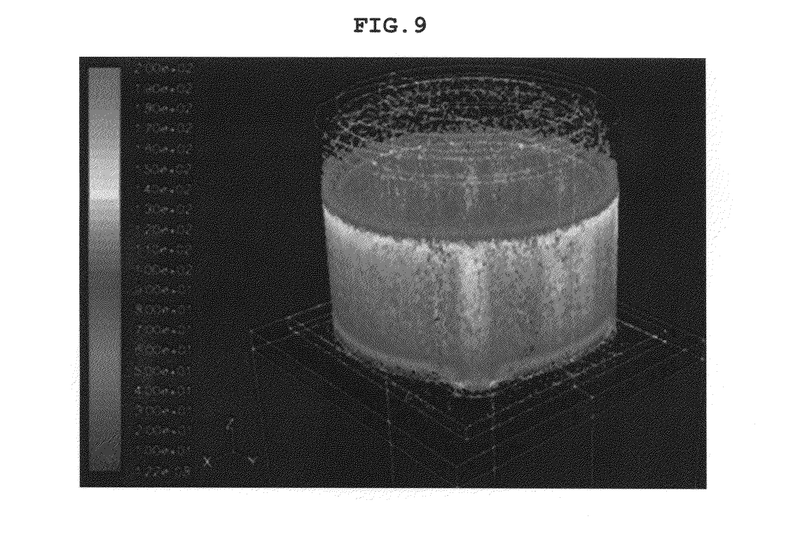

More specifically, HG. 7 shows the average velocity in the camera module when the upper portion of the housing is opened by the opening/closing unit in a negative pressure state and after about 1.0×10⁻⁶ second elapses, wherein the average velocity becomes about 4.5 m/s. FIG. 8 shows the average velocity in the camera module when the upper portion of the housing is opened by the opening/closing unit in a negative pressure state and after about 1.0×10⁻⁵ second elapses, wherein the average velocity becomes about 27 m/s. FIG. 9 shows the average velocity in the camera module when the upper portion of the housing is opened by the opening/closing unit in a negative pressure state and after about 1.7×10⁻⁵ second elapses, wherein the average velocity becomes about 38 m/s.

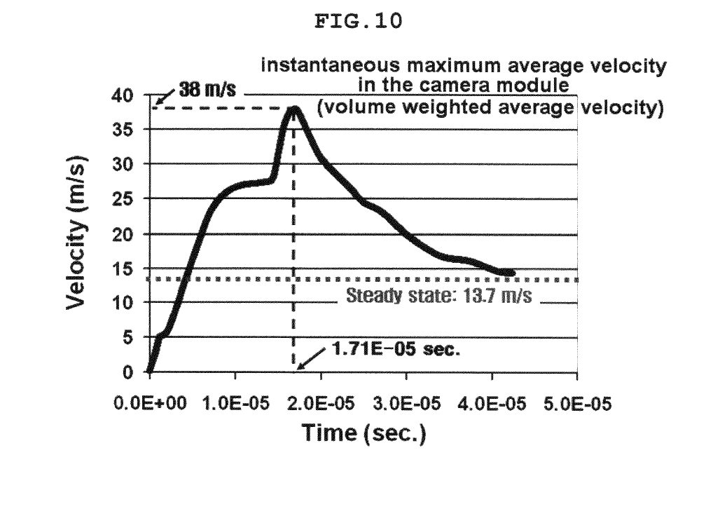

FIG. 10 is a schematic graph showing the velocity change in a camera module over time at the time of using the apparatus for cleaning the camera module according to the first embodiment of the present invention.

As shown in the graph, it shows the average velocity in the camera module over time, when the upper portion of the housing is opened in a negative pressure state.

As shown in the graph, the average velocity of the air is abruptly increased at an early stage and the slope of the graph shows acceleration, wherein the acceleration between early 0 to 3.1×10⁻⁶ seconds is 3.2×10⁶ m/s² and the acceleration between 1.5×10⁻⁵ to 1.7×10⁻⁵ seconds is 5.4×10⁶ m/s² and the instantaneous maximum average velocity is 38 m/s. This is the numerical value that is increased by about 2.8 times, considering that the average speed is about 13.7 m/s in the case of the simple suction method according to the related art.

In addition, when the suction pressure of the housing in which the camera module, the object to be cleaned is received, is increased using an air compression unit or vibration is formed in the air supplied to the housing the solenoid valve, the removal efficiency of the fine foreign substances is improved.

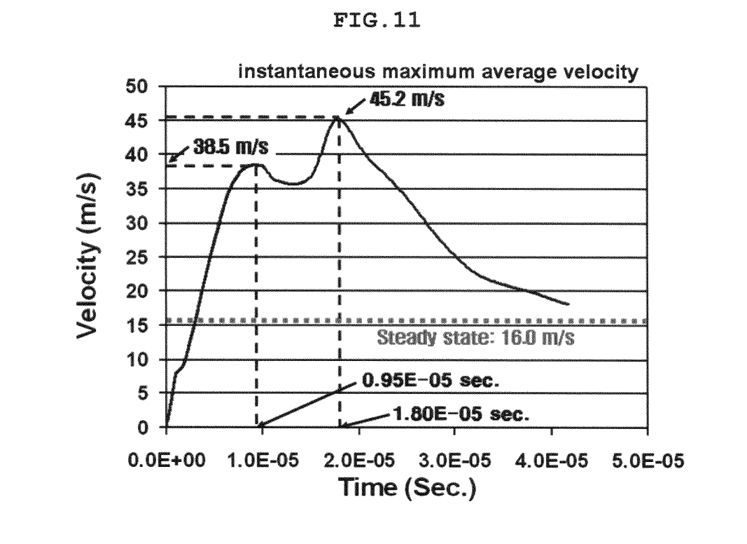

FIG. 11 is a schematic graph showing a velocity change in a camera module over time at the time of using the apparatus for cleaning the camera module according to the second embodiment of the present invention. As shown in the graph, two peaks can be appreciated in velocity.

More specifically, the instantaneous maximum average velocity where the first peak has the velocity similar to that shown in the graph of FIG. 10 according to the first embodiment, that is, 38.5 m/s, but the arrival time to the instantaneous maximum average velocity is 0.95×10⁻⁵ second. Therefore, it may be appreciated that the arrival time to the instantaneous maximum average velocity at the first peak is earlier by about 45% as compared to that to the instantaneous maximum average velocity according to the first embodiment of 1.71×10⁻⁵ second.

Further, in the second embodiment, the instantaneous maximum average velocity in the camera module at the second peak is 45.2 m/s. Therefore, it may be appreciated that the instantaneous maximum average velocity in the camera module is faster by about 20% than the instantaneous maximum average velocity according to the first embodiment of 38 m/s. Further, the arrival time to the instantaneous maximum average velocity is also 1.8×10⁻⁵ second. Therefore, it may be appreciated that the arrival time to the instantaneous maximum average velocity is almost similar to that to the instantaneous maximum average velocity according to the first embodiment of 1.71×10⁻⁵ second.

In conclusion, the apparatus for cleaning the camera module according to the second embodiment of the present invention further includes the compressed air injection apparatus and the diffuser as compared to the apparatus for cleaning the camera module according to the first embodiment of the present invention, thereby making it possible to more effectively remove the fine foreign substances of the camera module having the complicated structure.

The method for cleaning the camera module using the apparatus for cleaning the camera module according to the second embodiment of the present invention rapidly and repeatedly injects the air using the solenoid valve, thereby making it possible to generate vibration to the injected air. The possible range of vibration frequency is 1 to 200 Hz. This range is made by considering time rendered in making the insides of the camera module and the suction jig remain in a negative pressure state and discharging the air together with the fine foreign substances after the air is provided.

The proper vibration frequency provided to the air may be selectively implemented according to the sort and size of the fine foreign substances, wherein it is preferable that the vibration frequency of the air is implemented to be about 70 to 80 Hz in the case when the fine foreign substances have the size of 2 to 5 micron.

According to the present invention, the apparatus and the method for cleaning the camera module remove the fine foreign substances of the camera in such a manner that the instantaneous velocity of air supplied to the camera module is increased by receiving the camera module, the object to be cleaned, in a negative pressure state, and breaking the negative pressure state, thereby making it possible to clean the complicated and narrow inside of the camera module, and generates vibration of the supplied air using the opening/closing unit that rapidly and repeatedly opens/closes the upper portion of a housing, thereby making it possible to more effectively remove the fine foreign substances.

In addition, the apparatus and the method for cleaning the camera module receive the camera module in a negative pressure state and break the negative pressure state, simultaneously with generating vibration of introduced air using an opening/closing unit that injects high-pressure air and rapidly and repeatedly opens/closes the upper portion of a housing, thereby making it possible to more effectively remove fine foreign substances.

Although the embodiment of the present invention has been disclosed for illustrative purposes, it will be appreciated that an apparatus and a method for cleaning a camera module according to the invention are not limited thereby, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An apparatus for cleaning a camera module, comprising:
a housing in which a camera module, the object to be cleaned, is received;
an opening/closing unit that opens/closes the housing; and
an air suction unit that is connected to the housing and discharges air in the housing to the outside.

2. The apparatus for cleaning the camera module as set forth in claim 1, wherein the opening/closing unit is configured to include an opening/closing jig that repeatedly opens/closes the housing.

3. The apparatus for cleaning the camera module as set forth in claim 1, wherein the opening/closing unit is configured to include a solenoid valve that repeatedly opens/closes the housing.

4. The apparatus for cleaning the camera module as set forth in claim 1, wherein the opening/closing unit includes a sealing member that is positioned on a contact portion connected to the housing.

5. The apparatus for cleaning the camera module as set forth in claim 4, wherein the sealing member is configured to include a pad made of silicon or rubber.

6. The apparatus for cleaning the camera module as set forth in claim 1, wherein the air suction unit includes a suction jig that is connected to the housing; and an air suction pump that discharges air in the housing to the outside.

7. The apparatus for cleaning the camera module as set forth in claim 6, wherein the suction jig includes the sealing member that is positioned on the contact portion connected to the housing and is configured to include the pad made of silicon or rubber.

8. An apparatus for cleaning a camera module, comprising:
a housing in which, a camera module, the object to be cleaned, is received;
an air injection and sealing unit that seals the housing and includes a compressed air injection apparatus that selectively injects compressed air to the camera module in the housing; and
an air suction unit that is connected to the housing and discharges air in the housing to the outside.

9. The apparatus for cleaning the camera module as set forth in claim 8, wherein the air injection and sealing member has an air path inside the housing in order to transfer high-pressure air from the compressed air injection apparatus to the housing.

10. The apparatus for cleaning the camera module as set forth in claim 9, wherein a diffuser having a diameter increased toward the housing is formed on an end of the air path.

11. The apparatus for cleaning the camera module as set forth in claim 9, wherein the air injection and sealing unit further includes an opening/closing unit that opens/closes the air path.

12. The apparatus for cleaning the camera module as set forth in claim 11, wherein the opening/closing unit is configured to include a solenoid valve.

13. The apparatus for cleaning the camera module as set forth in claim 8, wherein the air suction unit includes a suction jig that is connected to the housing and an air suction pump.

14. The apparatus for cleaning the camera module as set forth in claim 13, wherein the suction jig further includes a sealing unit that is positioned on a contact portion coupled to the housing.

15. The apparatus for cleaning the camera module as set forth in claim 14, wherein the sealing unit is configured to include a pad made of silicon or rubber.

16. The apparatus for cleaning the camera module as set forth in claim 8, wherein the compressed air is ionized clean air.

17. A method for cleaning a camera module, comprising:
receiving a camera module, the object to be cleaned, in a housing;
sealing the housing an opening/closing unit;
discharging air in the housing to the outside using an air suction unit; and
repeatedly opening/closing the housing the opening/closing unit so that air is introduced into the inside of the housing.

18. The method for cleaning the camera module as set forth in claim 17, further including injecting compressed air when the housing is opened so that air is introduced into the upper portion of the housing.

19. The method for cleaning the camera module as set forth in claim 17, wherein the opening/closing unit is configured to include a solenoid valve and the air supplied to the inside of the housing is vibrated by the repetitive opening/closing of the solenoid valve.

20. The method for cleaning the camera module as set forth in claim 19, wherein the vibration frequency of the air generated by the solenoid valve is 1 to 200 Hz.
